(19) United States
(12) Patent Application Publication
(10) Pub. No.: US 2014/0244897 A1
(43) Pub. Date: Aug. 28, 2014

(54) Metadata Update Management In a Multi-Tiered Memory

(71) Applicant: SEAGATE TECHNOLOGY LLC, Cupertino, CA (US)

(72) Inventors: Ryan James Goss, Prior Lake, MN (US); David Scott Ebsen, Minnetonka, MN (US); Mark Allen Gaertner, Vadnais Heights, MN (US)

(73) Assignee: SEAGATE TECHNOLOGY LLC, Cupertino, CA (US)

(21) Appl. No.: 13/777,868

(22) Filed: Feb. 26, 2013

(51) Int. Cl. G06F 12/02

(52) U.S. Cl. CPC G06F 12/0246
USPC 711/103

(57) ABSTRACT

Method and apparatus for managing data in a memory. In accordance with some embodiments, metadata updates are stored in a first tier of a a multi-tier non-volatile memory structure responsive to access operations associated with data objects in the memory structure. The stored metadata updates are logged in a second, lower tier of the memory structure. The stored metadata updates are further migrated to a different location within the first tier responsive to an accumulated count of said access operations.

### SUMMARY

Various embodiments of the present disclosure are generally directed to managing data in a data storage device.

In accordance with some embodiments, metadata updates are stored in a first tier of a multi-tier non-volatile memory structure responsive to access operations associated with data objects in the memory structure. The stored metadata updates are logged in a second, lower tier of the memory structure. The stored metadata updates are further migrated to a different location within the first tier responsive to an accumulated count of said access operations.

These and other features and aspects which characterize various embodiments of the present disclosure can be understood in view of the following detailed discussion and the accompanying drawings.

### BRIEF DESCRIPTION OF THE DRAWINGS

FIG. 1 provides is a functional block representation of a data storage device in accordance with various embodiments of the present disclosure.

FIG. 2 illustrates exemplary formats for a data object and a corresponding metadata unit used to describe the data object.

FIG. 3 depicts storage of metadata updates, metadata logs and data objects in different respective tiers of the multi-tier memory structure of FIG. 1.

FIG. 4 depicts a storage manager and respective tiers of the memory structure in accordance with some embodiments.

FIG. 5 illustrates an interplay between the metadata updates in a metadata table stored in an upper tier and metadata logs stored in a lower tier.

FIG. 6 depicts periodic migration of the upper tier metadata table to different locations, such as garbage collection units (GCUs), in accordance with some embodiments.

FIG. 7 shows different operational stages of the GCUs in the various memory tiers of FIG. 4.

FIG. 8 illustrates a sample metadata format that can be used in accordance with some embodiments.

FIG. 9 is an example format for GCU sequence data from FIG. 8.

FIG. 10 is an example format for forward pointer data from FIG. 8.

FIG. 11 is an example format for a reverse directory table of FIG. 8.

FIG. 12 illustrates a forward search operation to locate a most current version of a data block using the GCU sequence data and forward pointers of FIGS. 9-10.

FIG. 13 depicts a metadata log circuit of the metadata engine of FIG. 4 in accordance with some embodiments.

### DETAILED DESCRIPTION

The present disclosure generally relates to the management of data in a data storage device.

Data storage devices generally operate to store blocks of data in memory. The devices can employ data management systems to track the physical locations of the blocks so that the blocks can be subsequently retrieved responsive to a read request for the stored data. The device may be provided with a hierarchical (multi-tiered) memory structure with different types of memory to accommodate data having different attributes and workloads. The various memory tiers may be erasable or rewriteable.

Erasable memories (e.g, flash memory, write many optical disc media, etc.) are non-volatile memories that usually require an erasure operation before new data can be written to a given memory location. It is thus common in an erasable memory to write an updated data set to a new, different location and to mark the previously stored version of the data as stale.

Rewriteable memories (e.g., dynamic random access memory (DRAM), resistive random access memory (RRAM), magnetic disc media, etc.) may be volatile or non-volatile, and are rewriteable so that an updated data set can be overwritten onto an existing, older version of the data in a given location without the need for an intervening erasure operation.

Metadata can be generated and maintained to track the locations and status of the stored data. The metadata tracks the relationship between logical elements (such as logical block addresses, LBAs) stored in the memory space and physical locations (such as physical block addresses, PBAs) of the memory space. The metadata can also include state information associated with the stored data and/or the memory location of the stored data, such as the total number of accumulated writes/erasures/reads, aging, drift parametrics, estimated or measured wear, etc.

Data management systems often expend considerable effort in maintaining the metadata in an up-to-date and accurate condition. Metadata failures can occur from time to time due to a variety of factors, including loss or corruption of the stored metadata, failures in the circuitry used to access the metadata, incomplete updates of the metadata during a power interruption, etc. In some cases, a metadata failure may result in an older version of data being returned to the host. In other cases, a metadata failure may render portions of, or the entire device, incapable of correctly returning previously stored data.

In some storage systems, certain types of metadata relating to the state of the system may be updated on a highly frequent basis. For example, a staleness count, indicative of the total number of stale blocks in a GCU, may be incremented during each write operation to that GCU. In high performance environments, this may result in several tens of thousands, or hundreds of thousands (or more) of state changes per second. Other types of state information may be similarly updated at a high rate, such as aging (e.g., data retention values) associated with the GCUs. Other types of metadata are relatively stable and do not change frequently, such as logical addresses, forward pointers, reverse directories, etc.

Accordingly, various embodiments of the present disclosure provide a multi-tiered memory structure adapted to store data objects and associated metadata. As explained below, the data objects are configured to store input blocks of data from a requestor (e.g., host device), and corresponding metadata are configured to provide control information associated with the data objects.

A plurality of metadata structures are formed; metadata updates representing most current, up-to-date metadata are stored in a metadata update table in a first tier of the multi-tier memory structure. Metadata logs representing older version metadata and/or history data associated with the metadata updates are stored in a second tier of the multi-tier memory structure. The data objects may be stored in yet a different third tier. The first tier may be an upper tier with faster I/0 response and other characteristics as compared to the second and third tiers. At least the first tier is a non-volatile rewritable memory.

The division of control data between the metadata updates and the metadata logs can be selected based on a number of factors. In some embodiments, a complete set of current version metadata is maintained in the first tier and older version snapshots of the metadata are logged to the second tier. In other embodiments, metadata portions that tend to receive high frequency updates may be maintained in the metadata update table, and metadata portions that tend to he updated less frequently may be maintained in the metadata log information.

The metadata table is maintained in rotating locations of the first tier based on endurance, drift and other memory attributes of the first tier to facilitate reliable recovery of the data. Maintaining the metadata updates in non-volatile memory reduces a likelihood of metadata loss in the event of a power loss or other disruptive event. In some embodiments, each time the metadata table is rotated to a new location in the first tier, metadata log data are transferred to the second tier.

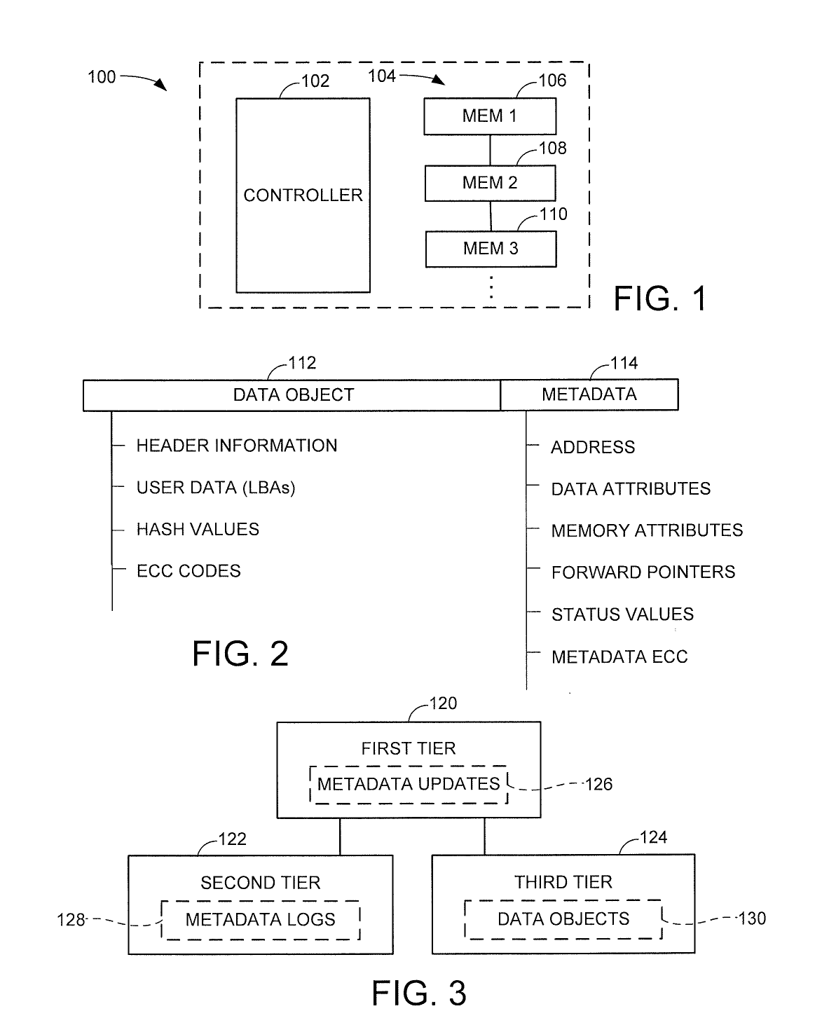

These and other features of various embodiments can be understood beginning with a review of FIG. 1, which provides a functional block representation of a data storage device 100. The device 100 includes a controller 102 and a multi-tiered memory structure 104. The controller 102 provides top level control of the device 100, and the memory structure 104 stores and retrieves user data from/to a requestor entity, such as an external host device (not separately shown).

The memory structure 104 includes a number of memory tiers 106, 108 and 110 denoted as MEM 1-3. The number and types of memory in the various tiers can vary as desired. Generally, the higher tiers in the memory structure 104 may be constructed of smaller and/or faster memory and the lower tiers in the memory structure may be constructed of larger and/or slower memory.

For purposes of providing one concrete example, the system 100 is contemplated as a flash memory-based storage device, such as a solid state drive (SSD), a portable thumb drive, a memory stick, a memory card, a hybrid storage device, etc. so that at least one of the lower memory tiers provides a main store that utilizes erasable flash memory. At least one of the higher memory tiers provides rewriteable non-volatile memory such as resistive random access memory (RRAM), phase change random access memory (PCRAM), spin-torque transfer random access memory (STRAM), etc. This is merely illustrative and not limiting. Other levels may be incorporated into the memory structure, such as volatile or non-volatile cache levels, buffers, etc.

FIG. 2 illustrates exemplary formats for a data object 112 and associated metadata 114 that can be used by the device 100 of FIG. 1. Other formats may be used. The data object 112 is managed as an addressable unit and may be formed from one or more data blocks supplied by the requestor (host). The metadata 114 provide control information to enable the device 100 to locate and retrieve the previously stored data object 112. The metadata will tend to be significantly smaller (in terms of total number of bits) than the corresponding data object to maximize data storage capacity of the device 100.

Depending upon the format, the data object 112 may include a variety of different types of data including header information, user data, one or more hash values and error correction code (ECC) information. The user data may be in the form of one or more data blocks each having a logical address, such as a logical block address (LBA) used to identify the data at the requestor level. The header information may be the LBA value(s) associated with the user data blocks or other useful identifier information.

The hash value can be generated from the user data using a suitable hash function, such as a Sha hash, to reduce write amplification by comparing the hash value of a previously stored LBA (or range of LBAs) to the hash value for a newer version of the same LBA (or range of LBAs). If the hash values match, the newer version may not need to be stored to the structure 104 as this may represent a duplicate set of the same user data.

The ECC information can take a variety of suitable forms such as outercode, parity values, IOEDC values, cyclical correction codes such as BCH or Read Solomon codes, checksums, etc. The ECC codes are used to detect and correct up to a selected number of errors in the data object during read back of the data.

The metadata 114 may include a variety of different types of control data such as address information, data attributes, memory attributes, forward pointers, status value(s) and metadata level ECC codes. Other metadata unit formats can be used. The address information identifies the physical address of the corresponding data object, and may provide logical to physical address conversion information as well. As various embodiments distribute different portions of the metadata to different tiers, the physical address information may also signify the locations of different portions of the metadata. Physical addressing may be in terms of tiers, dies, lanes, garbage collection units (GCUs), erasure blocks, rows, columns, cache lines, pages, bit offsets, and/or other address values.

The data attribute information identifies attributes associated with the data object 112, such as status, revision level, timestamp data, workload indicators, etc. The memory attribute information provides parametric attributes associated with the physical location at which the data object 112 is stored. Examples include total number of writes/erasures, total number of reads, estimated or measured wear effects, charge or resistance drift parameters, bit error rate (BER) measurements, aging, etc. These respective sets of attributes can be maintained by the controller and/or updated based on previous metadata entries.

The forward pointers are used to enable searching for the most current version of the data object 112. The status value(s) indicate the current status of the associated data object (e.g., stale, valid, etc.). The metadata ECC may provide a smaller ECC value than used in the data object and can be used to detect/correct errors in the metadata during readback.

FIG. 3 depicts first, second and third memory tiers 120, 122 and 124 of the memory structure 104. In accordance with some embodiments, metadata updates 126 are stored in the first tier 120, metadata logs 128 are stored in the second tier 122 and the data objects associated with the metadata updates and the metadata logs are stored in the third tier 124. This is merely exemplary and not limiting, as the respective data sets represented at 126-130 can be stored in any combination of suitable tiers. It is contemplated that the first tier will be an upper (higher) tier in the priority order of the memory structure 104 and the second and third tiers will be relatively lower tiers with respect to the upper tier.

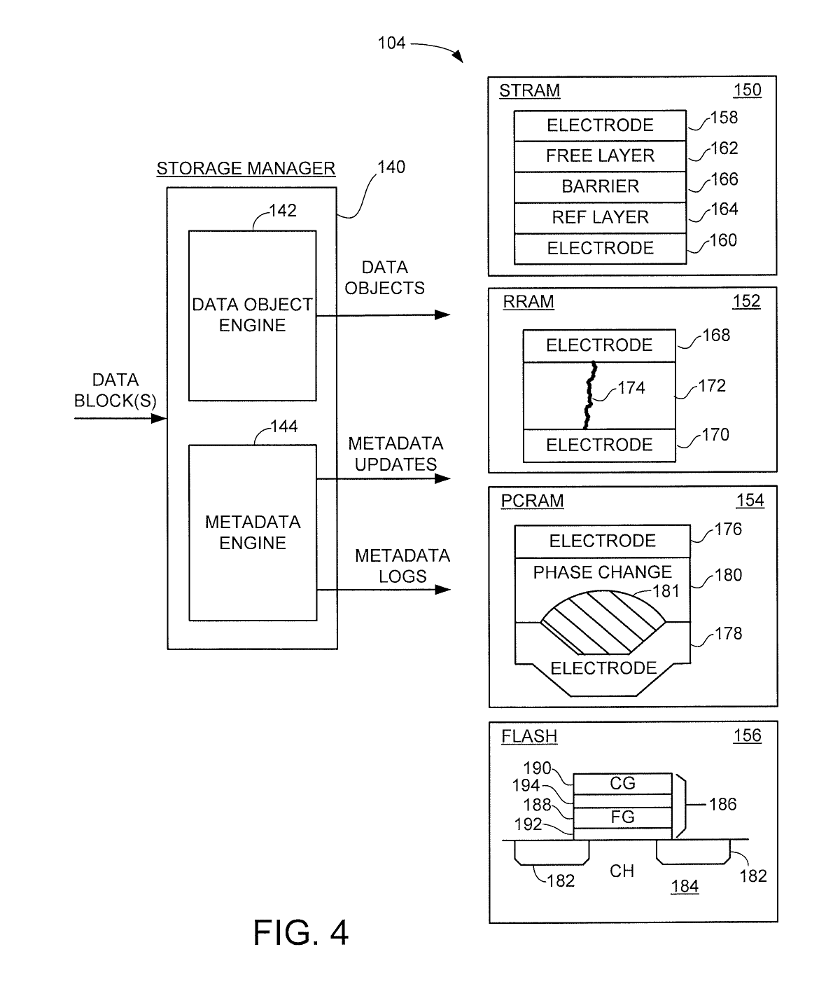

FIG. 4 depicts a storage manager 140 of the data storage device in conjunction with an example number of tiers of the memory structure 104. The storage manager 140 may be incorporated as a portion of the controller functionality, or can be realized as part of the memory structure. The storage manager 140 includes a data object engine 142 that generates data objects and a metadata engine 144 that generates metadata in the form of metadata updates and metadata logs which, as discussed in FIG. 3, are stored to different tiers in the memory structure.

The memory structure 104 in FIG. 4 is shown to encompass four tiers 150, 152, 154 and 156. Other formats and ordering of tiers can be used. The first tier 150 is shown to comprise spin-torque transfer random access memory (STRAM) memory cells, which are rewritable non-volatile memory cells each adapted to store data as a programmable electrical resistance. The exemplary STRAM cell includes upper and lower conductive electrodes 158, 160 which bound a magnetic tunneling junction (MTJ) formed of a free layer 162, reference layer 164 and intervening tunneling barrier layer 166. Other MTJ configurations can be used.

The free layer 162 comprises one or more layers of magnetically responsive material with a variable magnetic orientation. The reference layer 164 comprises one or more layers of magnetically responsive material with a fixed magnetic orientation. The reference layer may include a pinning layer, such as a permanent magnet, a synthetic antiferromagnetic (SAF) layer, etc., and a pinned layer, such as a ferromagnetic layer oriented magnetically by the pinning layer. The direction(s) of the magnetic orientation may be perpendicular or parallel to the direction of current through the MTJ.

The MTJ exhibits different electrical resistances in relation to the orientation of the free layer 162 relative to the reference layer 164. A relatively low resistance is provided in a parallel orientation, where the free layer is oriented in the same direction as the reference layer. A relatively high resistance is provided in an anti-parallel orientation, where the free layer is oriented in the opposing direction as the reference layer. Spin torque currents can be applied to transition the free layer between the parallel and anti-parallel orientations.

The second tier 152 comprises a non-volatile rewritable resistive random access memory (RRAM). Each RRAM cell comprises top and bottom conductive electrodes 168, 170 separated by an intervening layer such as an oxide layer or electrolytic layer. The intervening layer 172 normally has a relatively high electrical resistance.

During a programming operation, ionic migration is initiated which may result in the formation of a conductive filament 174 that lowers the electrical resistance through the RRAM element 172. Other RRAM configurations are contemplated that do not necessarily form a conductive filament, such as structures that undergo a change of state by the migration of ions or holes across a barrier or to an intermediate structure that results in a controlled change in resistance for the element.

The third tier 154 in the memory structure 104 in FIG. 4 comprises a non-volatile, rewritable phase change random access memory (PCRAM). Each PCRAM cell has top and bottom conductive electrodes 176, 178 separated a phase change material 180. The phase change material is heat responsive and transitions (melts) when heated to a temperature at or above its glass transition temperature. Depending on the rate at which the layer 180 is subsequently cooled, at least a portion of the material can take an amorphous or crystalline state, with respective higher and lower resistances. FIG. 4 shows an amorphous zone 181 indicating the cell is programmed to a high resistance state.

The fourth tier 156 is a flash memory tier made up of non-volatile, erasable flash memory cells. Doped regions 182 in a semiconductor substrate 184 form source and drain regions spanned by a gate structure 186. The gate structure includes a floating gate (FG) 188 and a control gate (CG) 190 separated by intervening barrier layers 192, 194. Data are stored to the cell in relation to the accumulation of electrical charge on the floating gate 188.

The flash memory cells are written (programmed) by applying suitable voltages to migrate charge from the channel to the respective floating gates 188. The presence of charge on the floating gate 188 of a cell increases the threshold voltage that needs to be placed on the control gate 190 to place the cell in a drain-source conductive state. The programmed states are read (sensed) by applying a succession of voltages to the respective drain, source and gate terminals to detect the threshold at which the cells are transitioned to a conductive state along the drain source path (across the channel CH). A special erasure operation is required to remove the accumulated charge and return the cell to an unerased, initialized state.

The flash memory cells may be arranged as single level cells (SLCs) or multi-level cells (MLCs). SLCs store a single bit and MLCs store multiple bits. Generally, each cell can store up to N bits of data by providing 2^{N} distinct accumulated charge levels. At least some of the various rewritable memory constructions of tiers 150, 152 and 154 can also be configured as SLCs or MLCs, depending on the construction and operation of the cells.

It is contemplated that each tier will have its own associated memory storage attributes (e.g., capacity, data unit size, I/O data transfer rates, endurance, etc.). The highest order tier will tend to have the fastest I/O data transfer rate performance (or other suitable performance metric) and the lowest order tier will tend to have the slowest performance. Each of the remaining tiers will have intermediate performance characteristics in a roughly sequential fashion in a priority order.

In some embodiments, the metadata updates may be stored to an upper tier, such as the RRAM tier 152, the data objects may be stored to a lower tier, such as the flash memory tier 156, and the metadata logs may be stored to an intermediate tier, such as the PCRAM tier 154. Any suitable tier or tiers can be used for these various data sets.

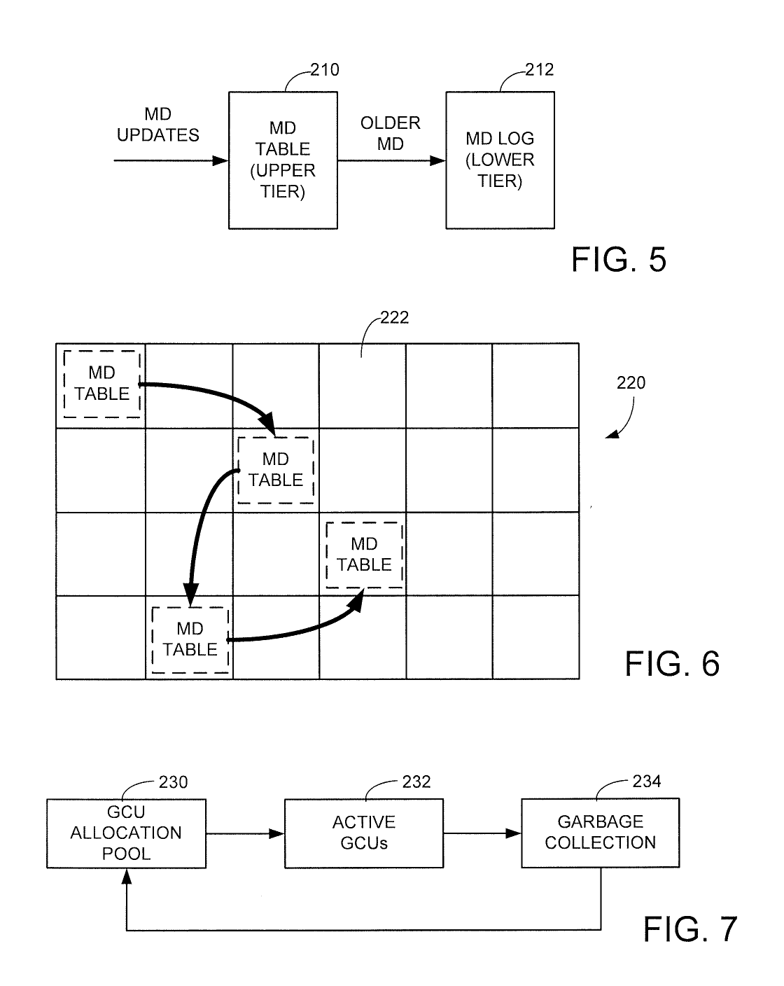

FIG. 5 illustrates interaction between the metadata updates and the metadata logs in accordance with some embodiments. Updates are supplied to a metadata table structure 210 from the metadata engine 144 of FIG. 4. The MD table 210 is maintained in the selected upper memory tier and represents the “working table” of current metadata for the servicing of normal data access (read and write) operations. Periodically, “snapshots” of at least a portion of the MD table data are transferred to one or more metadata log structures 212 stored in the lower memory tier.

In some embodiments, the MD table 210 stores all of the metadata necessary to locate all of the active data objects in the system. In other embodiments, highly updated metadata are maintained in the MD table 210 and other, more stable metadata that do not change on a frequent basis are maintained in the MD log structure 212, so that both the table 210 and the structure 212 are referenced to support a data access operation.

FIG. 6 depicts a portion of a selected upper memory tier 220 dedicated to the storage of the MD table 210. Because of the high rate at which updated data writes are made to the MD table 210, the dedicated portion of the memory tier 220 is divided into a number of different locations (subsets) of memory to which the table 210 is migrated on a regular basis. This provides wear leveling to the tier and ensures that the repeated writes from the frequently incremented state information do not induce resistance drift or other endurance related effects to an extent sufficient to reduce the ability to reliability recover the MD table data.

The metadata stored in both the MD table 210 and the MD logs 220 can vary widely based on the requirements of a given application. In some embodiments, the portions of the memory structure 104 dedicated to the storage of data objects (and as desired, the metadata table and logs) can be arranged in the form of garbage collection units (GCUs). Each of the memory tiers 150-156 in FIG. 4, for example, can be arranged into GCUs. Each GCU is a group of memory cells in a selected memory tier that is allocated and reset as a unit.

FIG. 7 depicts various operational stages of GCU processing. The GCUs in each tier may have the same total data storage capacity, or GCUs with different sizes can be used as required. GCUs can be dedicated to the storage of data objects, metadata or both, as desired.

A GCU allocation pool 230 represents a number of GCUs in a given memory tier that are available for allocation (use in storing data). Active GCUs 232 represent GCUs that have been allocated and are currently being used to store data. New data provided to a rewritable GCU may be overwritten onto existing data, although such is not necessarily required. New data provided to an erasable GCU, however, usually requires writing to the next available unwritten location in the GCU.

Over time, the GCUs in the active stage 232 will become filled with data. The data may become increasingly stale as newer versions of the data are stored in other GCUs. Moreover, even in the case where new data are overwritten onto existing data, over time the total accumulated number of access operations may be sufficient to degrade the overall performance of the GCU such as in the case of charge or resistance drift, etc.

Eventually, the active GCUs will be scheduled for garbage collection and transferred to stage 234. A garbage collection operation generally entails identifying currently valid data within the associated GCU, migrating the valid data to another location (e.g., a different GCU), and performing a reset operation to reset each of the memory cells in the GCU to a known programmed state. An erasure operation can be carried out for erasable memory cells. A write operation, including a specially configured write operation, can be carried out upon rewritable memory cells to write all of the cells to a known baseline state. Once the garbage collection operation is completed, the GCU is returned to the reallocation pool 230 pending subsequent allocation.

The decision to subject an active GCU to garbage collection can be based on a variety of factors, including system utilization requirements, aging, staleness, parametric performance, history information associated with the GCU, etc. Various types of state information can be maintained for each of the GCUs to aid in the garbage collection determination.

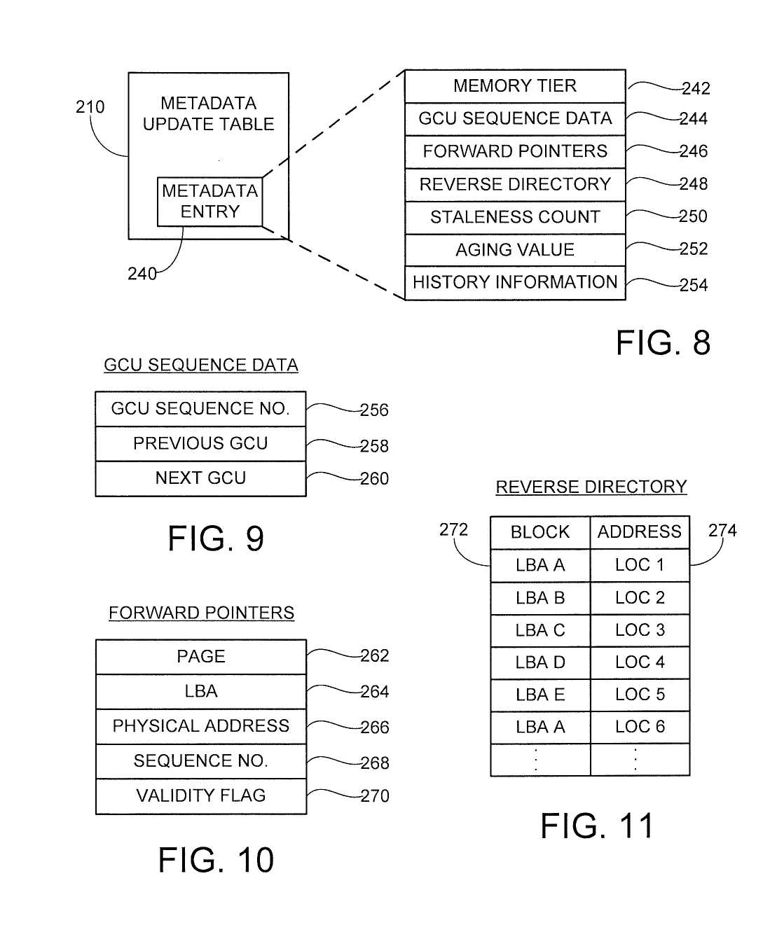

The metadata are accordingly arranged to track the status of the various GCUs in the various memory tiers. FIG. 8 depicts an example format for an entry 240 in the metadata update table 210 to track GCUs in a selected memory tier. Other formats can be used. The sample format for the metadata entry 240 is shown to include a memory tier identifier 242, GCU sequence data 244, forward pointers 246, a reverse directory 248, a staleness count 250, one or more aging values 252 and history information 254.

FIG. 9 shows the GCU sequence data 244 from FIG. 8 to include a number of fields such as a GCU sequence number field 256, a previous GCU 258 and a next GCU 260. The GCU sequence number field 256 stores a sequence number for the GCU to uniquely identify that GCU. This value can take a variety of forms including a physical or logical address for the GCU, an arbitrarily assigned value applied to the GCU upon allocation, an incremented count value assigned upon allocation, a time/date stamp associated with the allocation of the GCU, etc. The previous GCU value of field 258 takes a similar format and identifies the GCU that was allocated immediately prior to the current GCU. The next GCU value of field 260 also takes a similar format and identifies the GCU that was allocated immediately after the allocation of the current GCU.

The forward pointer data 246 from FIG. 8 is shown in FIG. 10 to include (for the flash memory tier 156) a page identifier field 262, an LBA (logical block address) field 264, a physical address field 266, a sequence number field 268 and a validity (staleness) flag 270. In some embodiments, forward pointer data as set forth in FIG. 10 is provided for each block of data stored in the GCU. The data may be set forth in a table form at the end of the GCU, in the form of headers at the beginning of each erasure block, as headers at the beginning of each page in the GCU, etc.

The page identifier identifies the page within the GCU at which the associated data block is stored. The LBA field identifies the logical address for the block, and the physical address field provides a corresponding physical address within the GCU for the block. The physical address may be a physical block address, PBA or other bit address data such as length, offset, etc. The sequence number can be a forward pointer pointing to a next location, such as a different GCU in which a newer version of the data block is stored. The validity flag can provide a staleness flag bit (e.g., flag=1 means current data; flag=0 means stale data).

FIG. 11 shows the reverse directory table 248 from FIG. 8 provides a listing of each block (e.g., LBA) 272 stored in the GCU and the associated address, or location 274, at which the block is stored in the GCU. The reverse directory is organized so that the location of each block (e.g., “sector” or “map unit”) of data listed in the directory represents a physical address within the GCU. These locations can be expressed as offsets from a starting physical address, or using some other convention.

The reverse directory is updated during each write operation to the GCU to identify the most recently written block to the GCU. The reverse directory table is written to the GCU as part of each data write operation so that no additional, separate writing operations are required to build and maintain the reverse directory table apart from the writing operations used to write the user data.

Referring again to FIG. 8, the staleness count 250 is an accumulated count of blocks in the associated GCU that are stale. As used herein, “stale” generally refers to blocks that are no longer the most currently active version of those blocks, such as older versions of particular LBAs, or blocks that are in a discarded state, such as those that make up files or data sets that have been “deleted” by the user. Maintaining a separate staleness count reduces the need for the system to evaluate the forward pointer data and evaluate each block in turn to determine how many blocks are stale within a given GCU.

The aging value can take a variety of forms, such as a time/date stamp value associated with the allocation of the GCU into the active stage. By subtracting the current time/date, an elapsed time interval can be determined. The aging value may reflect total elapsed time since allocation, or total operational time during that interval. Other formats for the aging value can be used as well, including elapsed time since the oldest access operation upon the GCU, etc.

The history information 254 of FIG. 8 generally relates to performance and use metrics associated with the GCU. The history information may be global information, such as information that has been accumulated for the entire service life of the GCU. The history information may additionally or alternatively be session based, such as accumulated information for the service life of the GCU since it was most recently allocated.

Parameters can take a variety of forms and may include total writes/erasure cycles;

total read operations; parametric drift measurements (e.g., read disturb, voltage drift, etc.); temperature data associated with the GCU, etc. The data may be combined into a combined/weighted measurement that indicates the state of the GCU using a bloom filter or other measurement algorithm.

During normal operation of the device 100, the metadata 114 or portions thereof may be retrieved from the MD table 210 directly by the controller as needed, so that all updated MD are maintained in non-volatile memory at all times. Alternatively, portions of the metadata from the MD table may be transferred to a local volatile memory for ready access by the controller, and updates to the metadata are initially made to the local volatile memory and transferred in near real time to the MD table 114 in non-volatile memory.

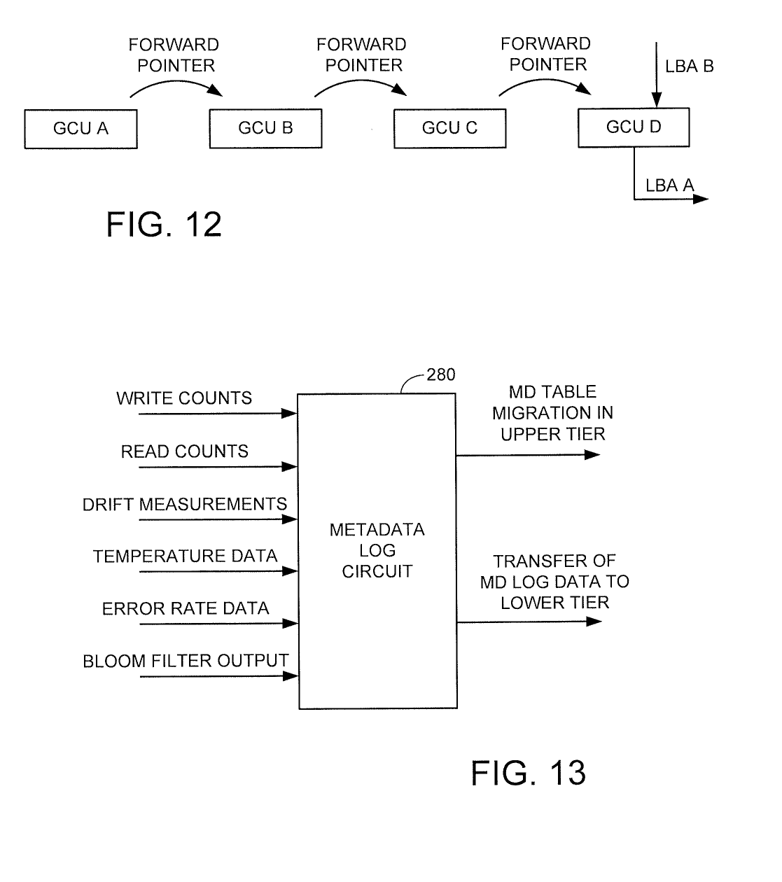

FIG. 12 generally represents forward search operations carried out during data access (read and write) operations. The forward pointers are arranged into a forward map. To read the most current version of an existing LBA, denoted in FIG. 12 as “LBA A,” the search methodology begins by identifying the oldest active GCU and searching the metadata to determine whether the GCU has any entries associated with the requested block. The oldest GCU (GCU A) is identified by examining the GCU sequence data (FIG. 9) of each of the allocated GCUs in the active stage (FIG. 7), and locating the GCU with the oldest sequence number.

The forward pointer data (FIG. 10) for GCU A is examined to determine whether any entries existed for LBA A within the GCU. The sequence of FIG. 12 shows that GCU A includes an entry for LBA A having a forward pointer to GCU B. The system proceeds to load and examine the forward pointer data for GCU B, which provides an entry with a forward pointer to GCU C. The forward pointer data for GCU C provides an entry with a forward pointer to GCU D. The forward pointer data for GCU D has a current entry indicating the physical address of the most current version of LBA A within GCU D (e.g., page, bits, offset, etc.). The system proceeds with a read operation upon this location and the requested LBA is output and returned to the host.

If the oldest active GCU does not provide an entry for the requested LBA, the system proceeds to search the next oldest active GCU and so on until either a forward pointer is located, the most current version of the LBA is located, or the data block is not found.

The forward search methodology of FIG. 12 is performed during a write operation to write a block of data (“LBA B”) by locating the oldest active GCU (GCU A) and searching the forward pointer data for entries listing LBA B, and following the pointers to each new GCU, which in this case is from GCU A to GCU B and then from GCU B to GCU C. For simplicity of illustration, the same GCU sequence is followed for both the read operation for LBA A and the write operation for LBA B, although it will be appreciated that each access operation may follow its own GCU sequence along the forward search. It will also be appreciated that the forward pointers may point to other locations within the same GCU and do not necessarily point to a different GCU.

In FIG. 12, the forward search finds the “then-existing” current version of LBA B to be stored in GCU C. The system proceeds to write the new version of data to GCU D, provide associated forward pointer data for this new entry, change the status of the metadata entry for LBA B in GCU C from “current” to “stale,” and add a forward pointer to GCU C to point to the new location for the written data in GCU D.

Various state information updates are carried out in conjunction with the foregoing read and write operations. These state information updates may include updating write and read counters are updated, updates to the reverse directory table with a new entry for the newly written LBA A block, temperature measurements, date code entries, staleness count updates, aging data updates, etc. This results in a high frequency of updating to the MD table 210. Depending on the configuration of the system, updates to certain state information may be on the order of several thousand or more updates per second.

Accordingly, FIG. 13 shows a log circuit 280 that forms a portion of the metadata engine 142 of FIG. 4. The log circuit 280 tracks the rate at which updates are written to the MD table 210, and periodically moves the MD table 210 to a new location within the selected tier in the manner depicted previously in FIG. 6.

The log circuit 280 utilizes a variety of inputs associated with the data access history of the MD table 210. These inputs can include write counts, read counts, drift measurements, temperature data, error rate data and bloom filter outputs. The write counts represent an accumulated count of write operations to the MD table. The write counts may be for all writes to the table, or an analysis of individual sets of data, such as an incremented state information value, that is repeatedly updated during system operation. The read counts input similarly tracks the total number of read counts to the MD table, either in total or to specific portions of the metadata.

Drift measurements provide estimated or measured changes in resistance of the various memory cells. Cells with relatively lower endurance characteristics will tend to degrade faster over time as compared to cells with higher endurance characteristics. The drift can be observed during normal operation or can be assessed by writing special test patterns and repetitively recovering the patterns while observing device characteristics. The temperature data generally relates to temperature measurements from one or more sensors. Generally, higher temperatures can affect memory cell performance and may accelerate the need to migrate the MD table to a new location.

Error rate data can similarly represent observed bit error rates (BER) during normal accessing of the metadata from the MD table. Other measurements, such as channel quality measurements, can be used to assess data integrity.

Finally, multiple parameters can be combined into a weighted value through the use of a bloom filter or other mechanism that, through empirical analysis, can provide an output value signifying the desirability of migrating the data to a new location.

Based on these and other suitable inputs, the metadata log circuit 280 periodicially outputs an indication signal at path 282 to initiate migration of the MD table to a new location in the upper tier. In some embodiments, the upper tier of memory dedicated to the storage of the MD table 210 is overprovisioned such as represented in FIG. 6 and each of the locations 222 is allocated and utilized as a metadata table garbage collection unit (GCU). In this way, the table can be stored in a first GCU 222, updated based on workload and, when appropriate, the table can be migrated to a second GCU 222 and the first GCU can be reset and returned to the allocation pool.

In this scheme, using a garbage collection process to migrate the MD table provides a suitable mechanism for generating log transfers to the lower tier, path 284. That is, each time that the MD table is moved to a new location 222 in the upper tier, a copy of the table, as it then exists, is simultaneously copied to the lower tier of memory and appended to the log structure 212 (FIG. 5).

In this way, the migrations and log transfers are carried out on a workload established basis, and generally, the difference between each successive log snapshot will constitute about the same number of data access operations/updates. The data may be moved in parallel; for example, the table data can be output to a buffer and transferred, in parallel to the new location (e.g., a second GCU) in the first tier and to the log structure in the second tier. As desired, the log data can also be maintained in a sequence of GCUs.

Additionally or alternatively, the migration of the MD table to a new location can be decoupled from the generation of the log data; that is, transfers of the MD log data can be carried out on a periodic time basis, such as at the end of each of a succession of predetermined time intervals (e.g., after every X hours, etc.).

While various embodiments presented herein have been directed to the logging of metadata updates, it will be appreciated that other forms of data can be similarly updated in this manner.

Numerous characteristics and advantages of various embodiments of the present disclosure have been set forth in the foregoing description, together with structural and functional details. Nevertheless, this detailed description is illustrative only, and changes may be made in detail, especially in matters of structure and arrangements of parts within the principles of the present disclosure to the full extent indicated by the broad general meaning of the terms in which the appended claims are expressed.

What is claimed is:

1. A method comprising:
storing metadata updates in a first tier of a a multi-tier non-volatile memory structure responsive to access operations associated with data objects in the memory structure;
logging the stored metadata updates in a second, lower tier of the memory structure; and
migrating the stored metadata updates to a different location within the first tier responsive to an accumulated count of said access operations.

2. The method of claim 1, in which the first tier comprises rewritable non-volatile memory cells arranged into a plurality of garbage collection units (GCUs) allocated and reset as a unit, the metadata updates are stored to a first GCU, and the different location to which the stored metadata updates are migrated comprises a different, second GCU.

3. The method of claim 2, in which the migration of the stored metadata updates to the second GCU further comprises resetting the rewritable non-volatile memory cells in the first GCU to a predetermined programmed state and moving the first GCU to a GCU allocation pool.

4. The method of claim 1, in which the logging and migrating steps are carried out in parallel to the first and second tiers.

5. The method of claim 1, in which the data objects are stored in a third tier of the memory structure comprising a plurality of erasable memory cells.

6. The method of claim 5, in which the first and second tiers comprise rewritable non-volatile memory cells with different constructions and storage attributes, and the third tier comprises flash memory cells.

7. The method of claim 1, in which the metadata updates comprise an incremented staleness count for a garbage collection unit (GCU) in the memory structure storing said data objects, the staleness count indicating a total number of stale data objects in the GCU.

8. The method of claim 1, in which the metadata updates comprise an aging value for a garbage collection unit (GCU) in the memory structure storing said data objects, the aging value indicating a total elapsed time since allocation of the GCU.

9. The method of claim 1, in which the metadata updates are stored in a table structure in a first location in the first tier, and the metadata updates are migrated to the different location responsive to a total number of update write operations to the table structure at the first location.

10. The method of claim 1, in which the multi-tier memory structure comprises a plurality of non-volatile memory tiers each having a different respective data transfer attributes and corresponding non-volatile memory cell constructions.

11. An apparatus comprising:
a multi-tier memory structure comprising a plurality of non-volatile memory tiers each having different data transfer attributes and corresponding memory cell constructions; and
a storage manager adapted to store metadata updates in a first tier of the non-volatile memory structure responsive to access operations associated with data objects in the memory structure, to log the stored metadata in a second, lower tier of the memory structure, and to migrate the stored metadata updates to a different location within the first tier responsive to an accumulated count of said access operations.

12. The apparatus of claim 11, in which each of the plurality of non-volatile memory tiers is arranged into a separate plurality of garbage collection units (GCUs) each allocated and reset as a unit, the metadata updates stored in a data structure in a first GCU in the first tier, the data structure concurrently transferred to a second GCU in the first tier and a third GCU in the second tier.

13. The apparatus of claim 12, in which the metadata updates comprise an incremented staleness count for a selected GCU in the memory structure storing said data objects, the staleness count indicating a total number of stale data objects in the GCU.

14. The apparatus of claim 12, in which the metadata updates comprise an aging value for a garbage collection unit (GCU) in the memory structure storing said data objects, the aging value indicating a total elapsed time since allocation of the GCU.

15. The apparatus of claim 11, in which the stored metadata are logged to the second lower tier by copying a data content of the first tier to the second tier.

16. The apparatus of claim 15, in which the data content is copied at the conclusion of a predetermined elapsed time interval.

17. An apparatus comprising:
a multi-tier memory structure comprising a plurality of non-volatile memory tiers each having different data transfer attributes and corresponding memory cell constructions, each tier arranged as a separate plurality of garbage collection units (GCUs) allocated and reset as a unit;
a data object engine adapted to generate and store data objects in selected GCUs of one or more of the plurality of non-volatile memory tiers responsive to receipt of data blocks from a requestor; and
a metadata engine adapted to generate and store metadata to describe the data objects, the metadata engine adapted to maintain a current version of the metadata in a first GCU in a first higher tier of the plurality of non-volatile memory tiers, and perform a garbage collection operation upon the first GCU by migrating the current version of the metadata to a second GCU in the first higher tier, copying the current version of the metadata to a log structure in a third GCU in a second lower tier and resetting the memory cells in the first GCU in the first higher tier to a common programmed state.

18. The apparatus of claim 17, in which each of the first higher tier and the second lower tier comprises rewritable non-volatile memory cells.

19. The apparatus of claim 17, in which the current version of the metadata comprises state information that is updated responsive to each data access operation upon the data objects.

20. The apparatus of claim 17, in which the garbage collection operation is performed upon the first GCU responsive to a total number of write operations upon the current version of the metadata in the first GCU since the first GCU was allocated.
